(19) United States
(12) Patent Application Publication
(10) Pub. No.: US 2009/0271243 A1
(43) Pub. Date: Oct. 29, 2009

(54) System and method of providing product quality and safety

(75) Inventors: Jeffrey J. Sholl, Minnetonka, MN (US); John E. Haaland, Saint Paul, MN (US); Susan K. Harlander, Jackson, WY (US)

Correspondence Address: WESTMAN CHAMPLIN & KELLY, P.A., SUITE 1400, 900 SECOND AVENUE SOUTH, MINNEAPOLIS, MN, 55402, US

(73) Assignee: BTSafety LLC., Eden Prairie, MN (US)

(21) Appl. No.: 12/429,251

(22) Filed: Apr. 24, 2009

Related U.S. Application Data
(60) Provisional application No. 61/047,928, filed on Apr. 25, 2008.

(51) Int. Cl. G06Q 10/00; G06F 3/048; H04N 5/225; G08B 21/00

(52) U.S. Cl. 705/9; 705/7; 715/708; 348/207.99; 340/540; 715/719; 348/E05.024

(57) ABSTRACT

In a particular embodiment, a portable, hand-held device to manage product quality and safety includes a processor and a memory accessible to the processor. The memory includes instructions executable by the processor to collect data related to a particular location and to generate a graphical user interface (GUI) including a plurality of user-selectable elements accessible by a user. The plurality of user-selectable elements includes a first user-selectable element to initiate playback of a training video, a second user-selectable element to receive user input associated with the particular location, and a third user-selectable element to display data indicating actions to be taken by the user in response to the collected data. The device further includes a display interface responsive to the processor and adapted to display the GUI.

### CROSS-REFERENCE TO RELATED APPLICATIONS

This application is a non-provisional application of and claims priority to U.S. Provisional Patent Application No. 61/047,928 filed on Apr. 25, 2008 and entitled “SYSTEM AND METHOD OF PROVIDING FOOD SAFETY,” which is incorporated herein by reference in its entirety.

### FIELD OF THE DISCLOSURE

The present disclosure is generally related to a system and method of providing product quality and safety, and more particularly, but not by limitation to, a system to provide product quality and safety and to provide enhanced efficiency and effectiveness.

### BACKGROUND

Companies are concerned with the negative impact of products that do not meet their critical quality and food safety standards. Production, processing, and finished food preparation systems designed to assure compliance can also increase operational productivity. However, such systems also utilize human oversight, and safe food products require vigilance and a great deal of knowledge and experience with respect to food handling.

In general, food monitoring usually involves experts from various fields, including scientific, engineering, and information system disciplines. In particular, food monitoring typically involves microbiologists, chemists, food technologists, human resource professionals, computer specialists, engineering staff, training staff, legal experts, government experts, or any combination thereof. Further, consulting companies, auditors, testing laboratories, and information technology companies may be included in the food monitoring process. However, such experts can make a difference in food safety at a particular location only when the workers at the particular location apply the knowledge to the work of producing, processing, cooking, and serving the customers that consume the food products and the management in charge has systems for monitoring such critical activities.

About 35 years ago, safe food became a cross-disciplinary challenge when the Pillsbury Company, under contract to the National Aeronautics and Space Administration (NASA), had to provide safe food for astronauts during missions. The Pillsbury Company identified critical risks in the process of producing the finished products, resulting in an analysis of potential hazards and the critical controls needed to eliminate or reduce the potential hazards. The resulting preventive approach became known as the Hazard Analysis and Critical Control Point (HACCP) system, which has become an international standard that is accepted by both businesses and governments. The HACCP system, which has been adopted by the National Restaurant Association, is generally regarded as the best overall approach to preventing food borne illness by actively controlling hazards throughout the food production process.

However, for the HACCP system to work, it is necessary for the food workers, the inspectors, and everyone involved in the food distribution process to know the hazards and to know the actions necessary to manage the critical control points. Critical control points can represent the place and time in a process where actions are needed to complete critical tasks. Critical tasks can be those actions required to achieve the most effective desired outcomes when performed at a critical control point. Further, the person who knows the hazards and the necessary actions should have the authority to make the necessary decisions to ensure the effectiveness of the control points. That authority includes the decision to take corrective action or to stop a process impacted by a control point failure until a proper assessment and corrective action are undertaken. The person having such authority is a “bell-ringer,” which is a person who is part of a trusted team whose action occurs before the “problem” occurs (before the problem impacts a consumer), as opposed to a “whistle-blower”whose action takes place after the “problem” occurs (after the problem impacts a consumer).

The importance of the bell-ringer stems from the effective response time. The person taking the action is the person closest to the actual activity. The effect on overall company performance is enormous. The close observation and management of critical safety controls ensures compliance with product specifications, which assures product quality and safety. Unfortunately, not all bell-ringers are the same. Hence, human variability in the system may compromise food safety and expose a company to recalls, to increased costs of production, legal liability, or any combination thereof.

### SUMMARY

In a particular embodiment, a portable, hand-held device to manage product quality and safety can include a processor and a memory accessible to the processor. The memory can include instructions executable by the processor to collect data related to a particular location and to generate a graphical user interface (GUI) including a plurality of user-selectable elements accessible by a user. The plurality of user-selectable elements may include a first user-selectable element to initiate playback of a training video, a second user-selectable element to receive user input associated with the particular location, and a third user-selectable element to display data indicating actions to be taken by the user in response to the collected data. The device further can include a display interface responsive to the processor and adapted to display the GUI.

In another particular embodiment, a system can include an interface responsive to a network and adapted to receive data and requests via the network, processing logic coupled to the interface, and memory accessible to the processing logic. The memory stores instructions executable by the processing logic to receive data from a remote device via the interface and can provide training data and critical task information to the remote device via the interface in response to the received data. The training data can include video data tailored for use at a particular location, where the training data is related to product quality and safety.

In still another particular embodiment, a hand-held device for inspecting a facility is disclosed that can include a speaker to output audio information and a display interface to display a graphical user interface including a window operable to provide instructions, to reproduce video data, other image data, text data, or any combination thereof, and to display user-selectable options related to inspection of the particular facility. The device further can include a processor coupled to the speaker and the display interface. The device can also include a memory accessible to the processor to store a plurality of instructions including instructions executable by the processor to receive data related to control points related to product safety and product quality at the particular facility, detect a product related problem based on the received data, and generate an alert to notify an employee about the product related problem.

### BRIEF DESCRIPTION OF THE DRAWINGS

FIG. 1 is a block diagram of a particular embodiment of a system to assist employees in providing product quality and safety and to provide production efficiency and effectiveness;

FIG. 2 is a block diagram of a particular illustrative embodiment of a system to provide product quality and safety and to provide enhanced efficiency and effectiveness;

FIG. 3 is a block diagram of a second particular illustrative embodiment of a system to provide product quality and safety and to provide enhanced efficiency and effectiveness;

FIG. 4 is a conceptual block diagram of a third particular illustrative embodiment of a system to provide product quality and safety and to provide enhanced efficiency and effectiveness;

FIG. 5 is a block diagram of a particular embodiment of a system to provide product quality and safety and to provide enhanced efficiency and effectiveness;

FIG. 6 is a flow diagram of a particular illustrative embodiment of a method to provide product quality and safety and to provide enhanced efficiency and effectiveness;

FIG. 7 is a flow diagram of a second particular illustrative embodiment of a method to provide product quality and safety and to provide enhanced efficiency;

FIG. 8 is a block diagram of a particular illustrative embodiment of a portable hand-held device including a user interface to receive data related to provide product quality and safety and to provide enhanced efficiency and effectiveness;

FIG. 9 is a diagram of a second particular illustrative embodiment of a portable hand-held device including a graphical user interface illustrating remediation instructions displayed at a portable device for use with a system to provide product quality and safety and to provide enhanced efficiency and effectiveness; and

FIG. 10 is a block diagram of a third particular illustrative embodiment of a system including a portable hand-held device.

### DETAILED DESCRIPTION OF ILLUSTRATIVE EMBODIMENTS

The following discussion introduces a system to provide product quality and safety and to enhance efficiency and effectiveness. The term “productivity” refers to a ratio of the output quality and quantity over the input quality and quantity which in management terms may be defined as follows:

Productivity=Efficiency and Effectiveness (Equation 1)

In this example, the term “Efficiency” implies performing a correct task faster, better, error free, and the like. The term “Effectiveness” refers to performing the right task, which is important for product quality and safety. The term “Quality” or “Quality Product” implies a safe product. But not all safe products are quality products. Thus, the term “Quality Product” also implies desirability of the product by the consumer. Correct standards must be separately selected for safety and quality, requiring the right information and resulting in the right task definitions. It may be possible to produce an unsafe, poor-quality product very efficiently, but it would not be an effective product and the sales volume would suffer. To achieve optimal productivity and/or to improve productivity, the production should include a combination of the production efficiency and effectiveness.

The system can include a server and a portable hand-held device, which can operate independently or in cooperation, to provide monitoring of critical control and safety points within a process. The server can include one or more databases including information related to governmental regulations, corporate standards, science and technology advances, facility specific information, or any combination thereof. The server can also include training information, including video data, audio data, text data, or any combination thereof. As used herein, the term “video data” refers to both still images and moving video.

The portable hand-held device can be used to gather facility-specific information, to detect quality control and/or safety problems, and to assist an employee in responding to the detected problem. In some instances, the device may provide a list of tasks to be completed in order to remediate the problem. In another instance, the device may permit tracking an on-going process in order to improve accuracy of outcome (such as a reduction of shrink). As used herein, the term “shrink” refers to a wasted difference between purchased inventory and what is actually sold to consumers. In another instance, the device may process collected information, determine the existence of a problem, and initiate an alert to notify an employee of the problem so that the problem can be corrected. In still another instance, the device may be adapted to notify expert personnel, a central office, a corporate quality control officer, other individuals, or any combination thereof of the problem, so that the particular individuals or groups may have input into a particular course of action. For example, in a product recall situation, a corporate officer and possibly legal professionals may be involved in determining that a recall is necessary and in determining how to initiate the recall.

The server and the hand-held device may be used in a variety of contexts, including service environments, processing environments, production environments, or any combination thereof. For the sake of clarity, the following discussion uses a food service or food production environment as the particular implementation, but it should be understood that the hand-held device and the server can be adapted to provide quality and safety monitoring for any number facilities in almost any industry.

In a particular embodiment, a system is disclosed that can be used to assist companies to meet critical food quality and food safety standards. In particular, the system can include a server system that has a database including data related to critical control points for one or more processes, problem detection data to assist in detecting problems, and remediation data to assist in correcting detected problems. Further, the server system can include training information, including video data, audio data, text data, or any combination thereof, that can be accessed and used by workers at a particular facility for training.

The system can also include portable, hand-held computing systems, such as portable computers, personal digital assistants (PDAs), mobile communication devices that include processors adapted to execute software applications, such as Internet browser applications, custom software applications, other applications, or any combination thereof. In a particular example, the portable hand-held computing system can include proprietary software that is modular, adaptable, and scalable. In a particular example, the software application to be run on the portable hand-held computing system can include a base module and one or more optional modules, where each of the one or more optional modules can be related to a specific service, process, or product. Further, the modules may be customized for a particular service provider, producer, or business. In the context of food, for example, such modules can include a food service module, a food processing module, and a food product module, each of which may be tailored to a specific business. In a particular example, selected modules can be downloaded (as needed) from a server system.

In a particular example, the server-based system, the portable hand-held computing system, or any combination thereof, can be used by restaurants, processing plants, product packing or packaging facilities, distributors, retailers, other service providers, other producers, or any combination thereof. Each environment where the system and/or the portable hand-held computing system are used may have an unique application program to meet specific safety and quality standards and to address facility specific efficiencies. For example, such safety and quality standards can be substantially different for a restaurant as compared to a commercial fishing boat. The server-based system and/or the portable hand-held computing system can be used in any environment where a real-time on-the-job response is critical and where decisions can be made based on immediate access to appropriate databases and actual experts, when the answer is not already included within a database or within a memory of the hand-held computing system.

In another example, in a food-related situation, when an employee encounters an unexpected situation (such as a violently ill customer in a restaurant or food service facility, a leaking roof in a food packing facility, or another unexpected situation), the portable hand-held computing system allows the employee immediately to photograph, label and communicate the problem and/or to look up remediation information to handle the unexpected situation. Alternatively, the portable hand-held computing system can be used to communicate directly with expert personnel to discuss the detected problem and possible remediation options. In a first embodiment, the remediation information is stored in a memory of the hand-held device. In a second embodiment, the remediation information can be retrieved by querying a database accessible via a network or by communicating data to actual experts when the answer is not already included in the database. In a particular embodiment, the network can be accessed (as needed) via wireless connection.

The ability to query a database to retrieve appropriate remediation information and/or to notify an appropriate person in management for an immediate answer can be a major benefit, in reducing shrink, in improving quality, and in enhancing productiveness and responsiveness. The hand-held computing system can be used to prompt an employee when it is time to check on critical control points. In a restaurant environment, the hand-held computing device can prompt an employee to check a temperature of a refrigeration unit (for example), to check a restroom for cleanliness, and the like. In a processing environment, the hand-held computing device can prompt an employee to retrieve a sample, for example. The hand-held computing device can also allow real-time queries, either to query a central system or to receive prompts from the central system or from a person at the headquarters (for example).

Further, the hand-held computing device can be used to track events that may be recurring or widespread. For example, in a restaurant chain, employees at different locations may report a common problem with an ingredient, such as ground beef appearing spoiled. Receipt of several such reports from different locations may trigger the central system to issue a notification in a short time-frame prompting employees at all locations to check their product.

Additionally, the ability to track such events can be used to systematically monitor a critical control point, providing a means for gathering information for a statistical sampling across lines or plants, or within a plant. Further, the hand-held computing device can include a camera to capture a photographic record of an event, which can be forwarded to an expert to assist in making an immediate decision and in formulating an appropriate response.

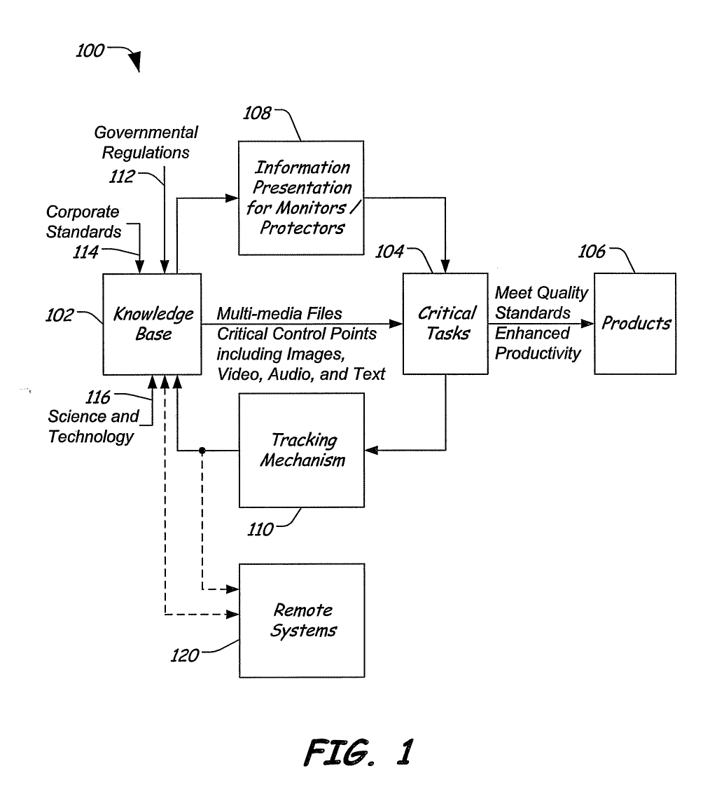

FIG. 1 is a block diagram of a particular embodiment of a system 100 to assist employees in providing product quality and safety and to provide production efficiency and effectiveness. The system 100 can include a knowledge base 102 including information to identify a set of critical tasks 104, which may be critical control points within a process or facility that determine product quality and safety and that dictate efficiencies and effectiveness. The system 100 can also include an information presentation device 108 for presenting information to human operators, such as quality control personnel. Further, the system 100 can include a tracking mechanism 110 for tracking data related to critical tasks 104.

It should be understood that, within the system 100, there are four over-arching aspects to producing high quality and safe products 106 that meet quality standards and with enhanced productivity (efficiencies and effectiveness). When quality or safety suffer, productivity is undermined, in part, because some products may need to be recalled, recycled, or discarded, depending on the product. Further, when quality or safety standards are not met, the producer may be exposed to liability via litigation, contractual obligations, and the like.

The knowledge base 102 may be assembled over time and can be kept up to date as new governmental regulations 112 are promulgated. Further, the knowledge base 102 may include corporate standards data 114, which may include best practices, corporation specific standards and requirements, other corporate information, or any combination thereof. Additionally, the knowledge base 102 may include science and technology information 116, including an up-to-date list of contaminants and remediation techniques, information about monitoring equipment, scientific literature, information from experts in the field, other information, or any combination thereof.

In an embodiment, the system 100 can be adapted to a particular company (such as a product distribution company, a restaurant chain, another type of company, or any combination thereof) or to a particular facility (such as a processing facility, a restaurant, another type of facility, or any combination thereof). To adapt the system 100, a group of trained professionals with working knowledge of the particular industry can be dispatched to the facility or to the company to develop an overall assessment of the company. In the food industry, such experts may include food quality, safety and management experts, who may have working knowledge of particular pathogens (such as e-coli and other contaminants) that can impact food quality and safety and of critical points that should be monitored to prevent contamination. In the restaurant industry, critical control points can include (but are by no means limited to) frequent hand-washing by employees, oven and refrigeration temperatures, time that a meal sits before being delivered to a customer, and so on.

It should be understood that quality and safety are also impacted by other companies and other systems, such as those that provide supplies to the company. In the restaurant industry, for example, the food distribution companies also play a role because they handle and deliver the food to the restaurant. Such handling is typically outside of the control of the restaurant, but can nevertheless introduce contaminants that can impact overall safety and quality.

The expert team develops an assessment, which can identify critical control points within a particular facility, within a company, within a production chain, or any combination thereof. As used herein, the term “critical control points” refers to one or more stages of production that play a role in the quality and safety of the end product. The assessment can include critical control points related to the product, the facility, the process, suppliers, ingredients, or any combination thereof. Further, the assessment can include control point data related to safety, training, operations, and efficient tasking.

Once the expert team completes the assessment (or at least once a portion of the assessment is completed), the assessment information can be input to a simulation system, which can be used to perform a variety of Monte Carlo type simulations to evaluate risks and liabilities associated with failures at the identified “critical control points.” In a particular embodiment, the simulations can be used to generate visualizations of risks and associated consequences to assist companies in identifying where they need to focus their efforts in order to enhance their on-going food safety and quality efforts.

Most companies build in barriers to contamination. In particular, they design facilities, processes, and devices to prevent or eliminate contamination. For example, in the food industry, flash pasteurization is used to reduce bacterial contamination in apple juice. In milk products, pasteurization can also be used. Further, some meats are irradiated to reduce e-coli contamination. Further, in some instances, the barrier to contamination may be built into the product itself. Such barriers can include additives, for example, to reduce a pH level. Each of these can represent a barrier to contamination. The simulations can be used to model the risks and consequences of a failure associated with any one of these barriers. The simulations can model and map the system when the systems are operating correctly and can be used to show how failure of any single barrier or process can impact the overall risk analysis.

In a particular instance, the risk modeling allows companies to evaluate where to invest their resources to improve their return on investment. Once the assessment is complete and the risk analysis is done, the knowledge base 102 can be updated with the critical control points (in some instances with a particular focus on those control points that have the greatest impact on product quality and safety, and optionally on efficiency and effectiveness).

After the assessment is completed and the knowledge base 102 is updated, the expert team may work with a team of software developers to develop custom systems for managing the identified critical control points. The custom systems can include hardware (such as sensors, video cameras, and other electronic devices) to monitor particular control points. The custom systems can also include software to gather information from the various sensors, cameras and other electronic devices. Further, the custom systems can include facility-specific training videos, check-lists, tasks, and other information, presented via the information presentation device 108, which can be carried by quality control and operations personnel to assist the individual in monitoring the critical control points. In some instances, the information presentation device 108 can be a portable, hand-held device, such as a portable computer, a mobile telephone (cellular or digital), a personal digital assistant (PDA), another electronic device, or any combination thereof. The information presentation device 108 can present critical control tasks to be performed by a human operator, which can be related to the critical tasks 104, and can collect input from the human operator, including text, user selections, pictures, audio information, video data, or any combination thereof. The data may be sent back via the tracking mechanism 110 to update the knowledge base 102.

In a particular embodiment, the knowledge base 102 provide multi-media files (including text data, audio data, video data, still image data, other data, or any combination thereof) to the information presentation device 108, which may identify critical tasks 104 to be performed by control personnel. The information may be viewed by the control personnel via the information presentation device 108. In a particular example, the information presentation device 108 may display a graphical user interface to present information and to receive user input. Further, the information presentation device 108 may be provided with a camera, a microphone, a speaker, and optional attachment devices to facilitate information gathering and to communicate collected data back to the knowledge base 102.

Once the hardware and software is in place, the system 100 can be brought on-line to provide real-time monitoring of a process or facility and to assist key personnel in monitoring, identifying, and remediating problems that might otherwise impact product quality and safety. The system 100 may include on-going monitoring and support to update the installation to manage new and emerging pathogens. Further, the system 100 can include remote systems, such as the remote systems 120 to provide remote backup monitoring to ensure compliance and to maintain and update the installation as needed. In a particular example, the remote systems 120 can include one or more computers that can communicate with the system 100 to receive and monitor data received via the tracking mechanism 110 (in real-time or near real-time) and to monitor and update the knowledge base 102, as needed. Further, in some instances, data related to governmental regulations 112, corporate standards 114, and science and technology 116 may be provided from the remote systems 120 or may be entered into the knowledge base 102 via other sources, such as by direct input by employees, data entry by other companies (such as a third-party regulation monitoring service), automated downloads from a server, or any combination thereof.

In the following discussion, the knowledge base 102 (or database) is assumed to already be updated with the critical control points determined by the team of experts. It should be understood that the systems described below may be coupled to remote systems, such as the remote systems 120, to provide on-going monitoring and updating of the respective installation. Additionally, it should be understood that the knowledge base 102 can be customized to a particular organization or facility or can be a general knowledge base 102 with some customizations. In a particular instance, the knowledge base 102 may be shared by multiple organizations and may provide custom facility-specific or product-specific information to the information presentation device 108 according to the particular company with which it is associated.

In an example, expert quality control and process management personnel may be able to review corporate policies and/or standards and to work in conjunction with senior management of the company to streamline processes and policies. In a particular example, redundant policies may be consolidated, and unenforced policies and out-of-date policies may be eliminated, simplifying and reducing the corporate policies to those that have the greatest impact on productivity. Some functions and tasks, which may be performed efficiently, may be eliminated, in part, because they are not necessarily effective. In some instances, such tasks may represent “busy work,” as compared to tasks that might have a greater impact on productivity.

As Peter Drucker stressed years ago, the greatest contribution to productivity is the replacement of a manual worker (assumed uninformed) with a knowledge worker (assumed informed). In an example, the system 100 relies upon a “bell-ringer” culture, where personnel can be tasked with responsibility for monitoring critical control points and for detecting problems and taking action to remediate any problems. In this example, reduction in effective response time is important, which requires the “bell-ringer” to be informed. First, the worker should know how to recognize that there is a problem, and then the worker should know the correct action to take to correct the problem. This level of skill requires training and may include management tracking of performance for verification purposes. The system 100 can provide training information, critical control point information, and instructions for remediating problems. Further, the system 100 can allow a user device to immediately photograph, label and communicate a problem to an expert or to other personnel and/or to look up remediation information.

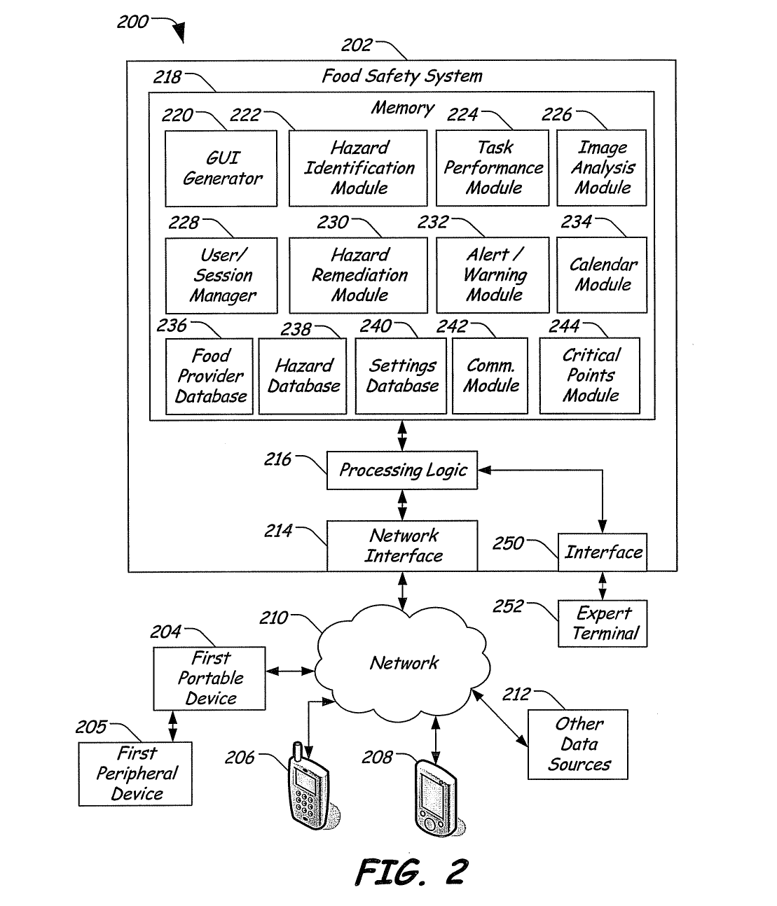

FIG. 2 is a block diagram of a particular illustrative embodiment of a system 200 to provide food quality and safety. The system 200 can include a food safety system 202 that communicates with multiple portable devices via a network 210. The multiple portable devices include a first portable device 204, a second portable device 206, and a third portable device 208. The food safety system 202 may also communicate with other data sources 212 via the network 210. In a particular embodiment, the network 210 can be a local area network, a wide area network (such as the Internet), a wireless network, or any combination thereof. Further, the other data sources 212 may be databases or other data resources hosted by various servers, including enterprise servers, governmental servers, a centralized monitoring system server, other servers, or any combination thereof. In a particular example, the network 210 is an enterprise network hosted by a particular food producing company. In another example, the network 210 can be the Internet. Additionally, while only three portable devices 204, 206, and 208 are shown, it should be understood that the food safety system 202 can be adapted to communicate with any number of portable devices. In a particular embodiment, each of the portable devices 204, 206, and 208 may access the food safety system 202 using a password or other security measure. In a particular example, the password can provide both authentication to the network and authorization to access particular tasks and information that is associated with the user, such that different passwords may provide different levels of access and different critical control point tasks. In a particular example, a supervisor, for instance, may be tasked with monitoring whether critical control point personnel visually inspect a particular process or location when prompted to ensure compliance. This task for a supervisor may be different from, but related to, a task to be performed by critical control point personnel. Further, training data for the supervisor may differ from that provided to other personnel.

The first, second, and third portable devices 204, 206, and 208 may be computing devices, such as laptop computers, handheld computers, web-enabled phones, personal digital assistants (PDAs), other computing devices, or any combination thereof. Additionally, the first portable device 204 may include an interface to communicate with a first peripheral device 205. In a particular example, the first peripheral device 205 can be an optical inspection device, a photoscopic device, a transducer related to a physical process, another device, or any combination thereof. The first peripheral device 205 may be used to detect bacteria at a particular facility, and the first portable device 204 can communicate data related to the detected bacterial information to the food safety system 202 via the network 210. In an embodiment, the first peripheral device 205 may also be able to interface directly with the network 210 via a wireless connection.

The food safety system 202 can include a network interface 214 that is communicatively coupled to the network 210. The food safety system 202 further can include processing logic 216 that is coupled to the network interface 214 and can include memory 218 that is accessible to the processing logic 216. In a particular embodiment, the memory 218 and the processing logic 216 may be distributed across a plurality of computing devices. The memory 218 stores multiple modules that are executable by the processing logic 216 to provide inspection tasks, to receive data related to the inspection tasks, to detect a food event based on the received data, and to provide remediation data related to the detected food event. The remediation data can include tasks to be performed by a user to rectify a food event. The food safety system 202 may also include an interface 250 that is coupled to the processing logic 216 and that is adapted to communicate with an expert terminal 252, which may be used by an operator to provide real-time or near-real time expert advice/oversight for assisting remote users. In a particular example, the expert advice/oversight may include detection of a food event based on image or other data received from the user.

The memory 218 can include a graphical user interface (GUI) generator 220 that is executable by the processing logic 216 to generate a GUI that can include data, instructions, graphics, visualizations related to data, or any combination thereof. The memory 218 can also include a task performance module 224 that is executable by the processing logic 216 to provide a list of inspection tasks that represent critical control points at a particular facility to guide a user through an inspection process. The task performance module 224 can also include an associated tracking feature to permit progress tracking with respect to the identified remediation tasks. Further, the task performance module 224 is adapted to receive user input related to performance of particular tasks. The memory 218 can also include a hazard identification module 222 that is executable by the processing logic 216 to search one or more data sources based on the received data. The one or more data sources can include a hazard database 238 and the other data sources 212 to identify a food event, such as a food handling error, a contamination event, a contaminated food product, or any combination thereof. The hazard identification module 222 is executable by the processing logic 216 to search the one or more data sources based on input data received from one or more of the portable devices 204, 206 and 208. Further, the hazard identification module 222 is adapted to determine a likely pathogen, contaminant, biological agent, other problems, or any combination thereof.

In a particular embodiment, the memory 218 further can include a hazard remediation module 230 that is executable by the processing logic to identify a set of remediation tasks to correct a food-event. The memory 218 can also include an image analysis module 226 that is executable by the processing logic 216 to process a digital image received from one of the portable devices 204, 206, or 208. In a particular example, the image analysis module 226 is adapted to process the digital image to identify a food event. The memory 218 further can include a user/session manager 228 that is executable by the processing logic 216 to authenticate and authorize access to the food safety system 202 by one or more of the portable devices 204, 206, and 208. The user/session manager 228 may control access to the food safety system 202 based on username/password data, biometric data, other security features, or any combination thereof.

The memory 218 can also include an alert/warning module 232 that is executable by the processing logic 216 to generate an alert based identification of a food hazard via the hazard identification module 222. In a particular embodiment, the generated alert can be a phone call, an email message, an instant message, an electronic page, another alert, or any combination thereof.

The memory 218 can also include a calendar module 234 that is executable by the processing logic 216 to provide a scheduling feature accessible to the portable devices 204, 206, and 208 to schedule tasks, such as a follow up to verify progress in remediation of an event and to verify on-going compliance. The memory 218 can also include a food provider database 236 that can include data related to one or more food producers and food handlers. In a particular example, the food provider database 236 can include data accessible to only one company, including a list of its suppliers, stores, and other company information. In another particular example, the food provider database 236 can include data related to numerous companies within a food distribution chain. In a particular embodiment, the food provider database 236 can include product specification data associated with one or more food processing facilities. The product specification data can include control point inspection data that can be used by the task performance module 224 and the hazard identification module 222 to provide inspection tasks, in-process control requirements and food contamination detection services.

The memory 218 may also include a settings module 240 that can include data related to preferences for communications, alerts, data visualizations, and other information that may be used to customize the presentation of information to a particular user. For example, the settings module 240 can include a setting to indicate a user-preferred communication method for particular types of alerts. For example, one user may prefer a text message while a second user may prefer an audio alert via a telephone call when a food event is detected. Further, the memory 218 can include a communications module 242 that is executable by the processing logic 216 to communicate with the portable devices 204, 206, and 208 and to communicate with other devices. In a particular embodiment, the communications module 242 is adapted to generate text messages, email messages, audio alerts, other data messages, or any combination thereof. Further, the communications module 242 is adapted to originate telephone calls, to generate small message service (SMS) messages, to initiate telephone calls, to initiate text-chat communications, to convert data into various data transmission formats, or any combination thereof. Further, the memory 218 can include a critical points module 244, which can include data related to a plurality of critical control points (CCPs), such as temperature for stored foods, temperature of particular processes, other variables, or any combination thereof. In a particular example, the critical points module 244 can generate alerts to prompt a user (employee) to inspect particular control points and/or to gather data related to one or more control points.

In a particular embodiment, the first, second, and third portable devices 204, 206, and 208 may be used to collect data related to food processing at particular processing facilities. For example, the first portable device 204 can be used to collect data related to restaurants, grocery stores, food processing plants, food storage facilities, food production and harvest operations, other locations, or any combination thereof. The first, second, and third portable devices 204, 206, and 208 communicate data related to food processes at critical control points to the food safety system 202. In a particular embodiment, the data can include text, images, or any combination thereof. The first, second, and third portable devices 204, 206, and 208 are adapted to receive user input, to transmit data related to the user input to the food safety system 202 via the network 210, and to receive remediation data from the food safety system 202 in response to the transmitted data. The remediation data can include one or more actions to be taken by the user to correct a food event. In a particular embodiment, each of the first, second, and third portable devices 204, 206, and 208 may include an integrated display, and each portable device can provide a graphical user interface (GUI) including the one or more actions to its display.

In a particular example, the food safety system 202 is responsive to the network to receive data from a portable device, such as the first portable device 204. The received data represents inspection data related to critical control points at a food facility. The food safety system 202 is adapted to process and store the received data and to search various data sources, such as the hazard database 238 and other data sources 212 to identify a food hazard based on the extracted data. The food safety system 202 may communicate data related to the identified hazard to the first portable device 204, including a list of remediation actions to be undertaken by the user to correct the food event. The food safety system 202 may receive data related to completion of the various remediation actions and may track progress associated with the list of remediation actions. In a particular embodiment, the food safety system 202 may utilize the food provider database 236 to generate a set of inspection tasks based on critical control points specific to that facility. Similarly, the remediation actions may be specific to the particular facility.

In a particular embodiment, the food safety system 202 can be utilized by management to enhance productivity, improve safety and quality, and reduce waste (shrink) at a particular location. In particular, by improving safety and by monitoring critical control points at a facility, waste due to poor quality control can be reduced. In a particular example, in a food processing facility, temperature measurements that are below quality standards may lead to undercooked meat, but frequent inspection and correction of such control points can lead to reduced waste and better quality. In an assembly line type of production process (food or other products), such monitoring can improve product quality and reduce the number of packaged units that may have sub-par quality, thereby improving productivity and reducing waste (shrink). In a restaurant or food service facility, tracking quantities of discarded ingredients and packaged products permits better management and control of waste, thus reducing shrink.

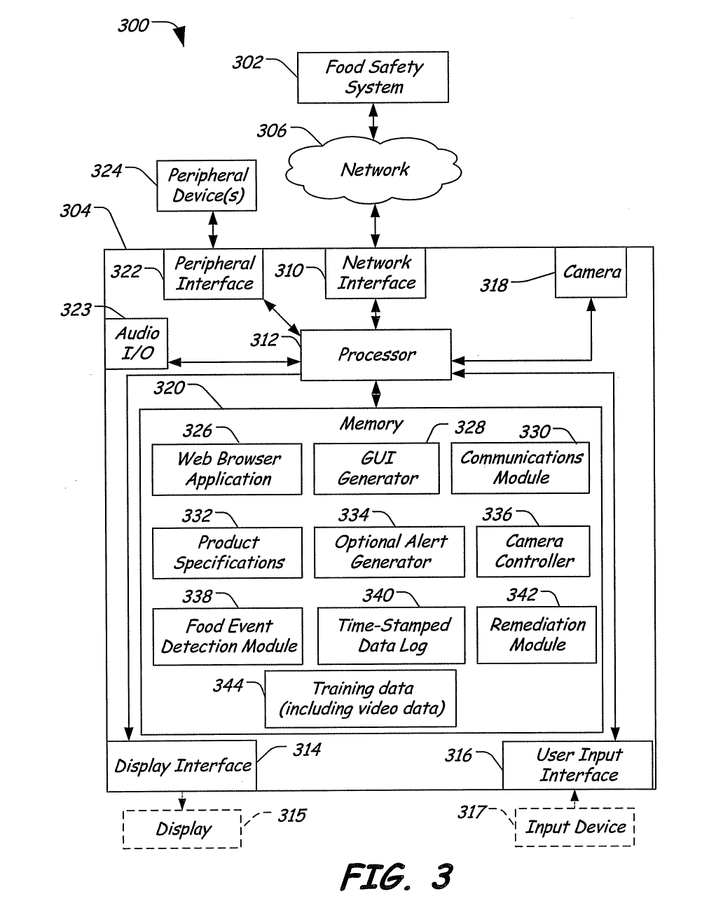

FIG. 3 is a block diagram of a particular illustrative embodiment of a system 300 to provide food safety. The system 300 can include a food safety system 302, such as the food safety system 202 illustrated in FIG. 2, which communicates via a network 306 with one or more portable devices, including a portable device 304. The network 306 may be a local area network, a wireless network, the Internet, or any combination thereof. The portable device 304 is a portable computing device, such as a laptop computer, a personal digital assistant (PDA), a mobile phone, a music player device with network communication functionality, another hand-held electronic device, or any combination thereof.

The portable device 304 can include a network interface 310 that is coupled to the network 306 and that is adapted to communicate with the food safety system 302 via the network 306. The portable device 304 can further include a processor 312 and a memory 320 that is accessible to the processor 312. The portable device 304 can further include a display interface 314 that is coupled to the processor 312 and that is adapted to display a graphical user interface. In a first embodiment, the display interface 314 can include an integrated display device (such as a touch screen or liquid crystal display (LCD)). In another embodiment, the display interface 314 may be adapted to communicate with an external display device 315.

The portable device 304 can also include a user input interface 316 that is coupled to the processor 312 and that is adapted to receive user input. In a first embodiment, the user input interface 316 can be associated with a display (e.g., a touch screen) or can be integrated within the portable device. In an example, the user input interface 316 can include a keypad, a keyboard, a stylus, another input device, or any combination thereof. In another particular embodiment, the user input interface 316 can be coupled to an input device 317, such as a keyboard or another input device.

The portable device 304 may also include a camera 318 that is coupled to the processor 312 and that is adapted to capture a digital image. The portable device 304 may also include a peripheral interface 322 that is coupled to the processor 312 and that is adapted to communicate with one or more peripheral devices 324. In a particular embodiment, the one or more peripheral devices 324 may include a photoscopic device, a sensor, a contamination detection device, or any combination thereof. The portable device 304 can utilize the one or more peripheral devices 324 to detect a food event and to communicate data related to the food event to the food safety system 302 via the portable device 304. Additionally, the portable device 304 can include an audio input/output (I/O) interface 323, which may include a speaker to output audio data and a microphone to receive audio input.

The memory 320 can include a web browser application 326 that is executable by the processor 312 to generate a web browser window for display at the display interface 314. The memory 320 can also include a graphical user interface generator 328 that is executable by the processor 312 to generate a user interface including one or more user-selectable indicators, such as buttons, directed links, tabs, check boxes, text inputs, other interactive elements, or any combination thereof. The generated user interface may be provided to the display interface 314 within the web browser window provided by the web browser application 326.

The memory 320 can further include a communications module 330 that is executable by the processor 312 to facilitate communication between the food safety system 302 and the portable device 304 in a variety of formats, including text, instant message, chat, Voice over Internet Protocol (VoIP), digital wireless formats, other formats, or any combination thereof. In a particular embodiment, the digital wireless formats can include a wireless telephone protocols or a short-range wireless protocols, such as an 802.11x communications protocol. In a particular example, the communications module 330 is executable by the processor 312 to receive user input from the user input interface 316 and to convert the user input into a desired format for communication to the food safety system 302. In a particular embodiment, the display interface 314 can be a touch screen that is adapted to provide visual data and to receive user input responsive thereto.

The memory 320 can also include an alert generator 334 that is executable by the processor 312 to generate an alert signal, such as an audible alarm, a visual alert, a text alert, a command, a tactile signal (e.g., vibration), another signal, or any combination thereof. In a particular example, the alert generator 334 can include digital signal processing features, including text-to-speech converters, to convert text into an audio alert signal. The alert signal may be communicated to the display interface 314, to the audio I/O interface 323, to the food safety system 302, or any combination thereof. The memory 320 can also include a camera controller 336 that is executable the processor 312 to control the operation of the camera 318 to capture digital images in response to a user input.

The memory 320 may also include a food event detection module 338 and a remediation module 342, which are executable by the processor 312 to detect a food event in response to user inputs and to generate a list of remediation actions based on the detection. The remediation tasks may be provided to the GUI generator 328 and presented to the user via the GUI at the display interface 314. The memory 320 may also include product specification data 332 that specifies ingredients, process information, menu data, and other data related to critical control points within a food process. The product specification data 332 can include ingredients and packaging specifications. In produce, the product specification data 332 can be a specified fruit or vegetable, and in a food service, the product specification data 332 can be a specified menu item. The memory 320 may also include a time-stamped data log 340, which may be accessed by the processor 312 to store information related to a food event. Further, the memory 320 can include training data 344, including video data, audio data, other data, or any combination thereof, which can be accessed by an employee for instructions and examples demonstrating how to perform particular inspection tasks, for example. Such training data 344 can include any information deemed appropriate for personnel at a particular facility (location) and can be tailored to meet the specific quality and safety standards of the particular facility. In a particular embodiment, the training data 344 can include information related to a server (such as the food safety system 302) from which additional training data can be retrieved (as needed).

In a particular illustrative example, a user may carry the portable device 304 into a facility to conduct a food safety inspection. The processor 312 may execute the web browser application 326 and/or the GUI generator 328 to generate a GUI for display at the display interface 314 that provides a series of inspection points to guide the user through the inspection process. The particular inspection points may be derived from the product specification information 332 to specify particular control points that require inspection.

The user may interact with user-selectable elements within the GUI via the user input interface 316, which may be a pointer, a mouse, a keypad, a touch screen, or any combination thereof. Alternatively, the display interface 314 may be a touch screen adapted to display the GUI and to receive user input. The user may input data related to the particular inspection points, which the portable device 304 may utilize to identify a potential contamination event (i.e., a food event). The portable device 304 can detect the food event using the food event detection module 338 or may send data related to the user input to the food safety system 302, which identifies the food event based on the user input and which provides identification information to the portable device 304. In a particular embodiment, the portable device 304 may determine remediation actions to be taken by the user using the remediation module 342 based on the identified food event. Alternatively, the food safety system 302 may determine remediation actions to be taken by the user and may provide the data to the portable device 304. In a particular embodiment, the GUI generator 328 is adapted to generate a second GUI including the remediation actions to be undertaken by the user. The second GUI can be displayed at the display interface 314. In a particular example, the GUI can include one or more user-selectable indicators, such as buttons, checkboxes, tabs, and other indicators, which the user may access to retrieve additional information, to indicate completion of a task, or to provide user input.

In a particular example, a user may not know the implications of a particular situation. In other words, an untrained or inexperienced user may not recognize particular problems. In this instance, a user may use the portable device 314 to capture a digital image of a particular item using the camera 318 and may use the GUI to transmit the digital image to the food safety system 302 for review and analysis. In a particular example, the digital image may be provided to a more experienced inspector or an expert system for analysis via a user terminal, such as the expert terminal 252 illustrated in FIG. 2. An operator may utilize the expert terminal (such as the expert terminal 252 illustrated in FIG. 2) at the food safety system 302 to communicate directly with the user of the portable device 304 in order to discuss additional conditions, to allow for questions, to provide further inspection guidance, or any combination thereof.

In general, the food safety systems 202 and 302 and the associated portable devices 204, 206, and 208 described with respect to FIGS. 2 and 3 provide a user-friendly system that can be used to perform food inspections. In particular, even relatively inexperienced inspection personnel may provide reliable inspections by following the inspection points and remediation tasks provided via the portable devices. Further, when questions arise, the portable device provides a means for communicating with an expert at the food safety system using images, text, or voice communications, which can enhance the effectiveness of the inspection process.

Referring to FIGS. 2 and 3, in a particular embodiment, the portable devices 204, 206 and 208 in FIG. 2 and the portable device 304 in FIG. 3 may be adapted to receive measurement data and other data associated with a process. In a particular example, the data can be received from sensors via a wireless interface or via a detachable wired interface. In a particular example, sensors can be installed within particular devices (such as ovens and refrigeration units in a food service environment) and can be adapted to communicate measurement data to the hand-held device. Further, the data can be collected via manual input. In a particular embodiment, sensors with wireless transceivers (not shown) may be installed at various control points within a process to be monitored. The portable device can collect data received from the wireless transceivers to monitor quality and safety at a particular facility.

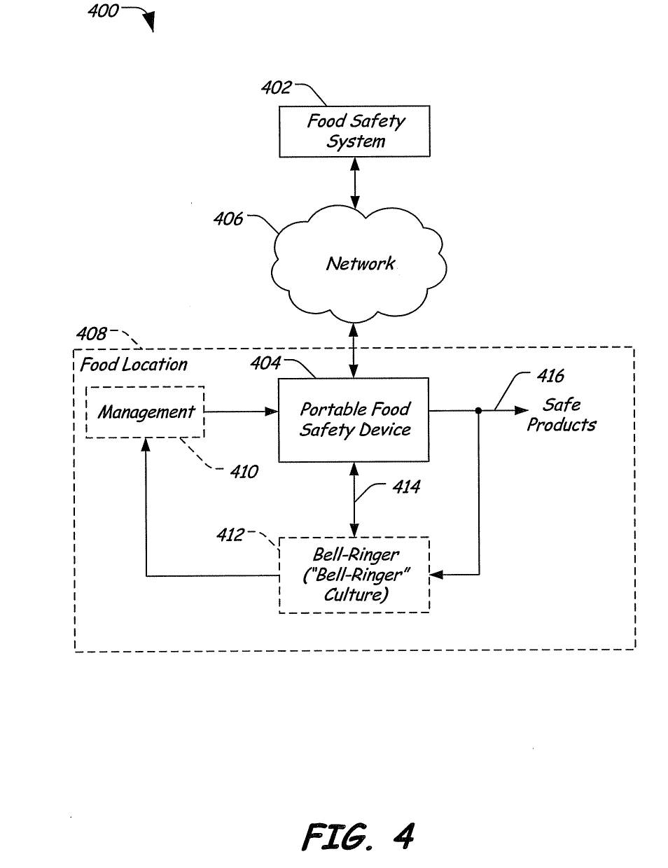

FIG. 4 is a conceptual block diagram of a particular illustrative embodiment of a system 400 to provide food safety. The system 400 can include a centralized food safety system 402 that communicates with a portable food safety device 404 via a network 406 to remotely monitor a food location 408. In general, the portable food safety device 404 uses management data 410 and a bell-ringer culture 412 including bell-ringer early detection input 414 to provide safe food products 416. In general, the portable food safety device 404 and the food safety system 402 are both management tools for improving productivity and food safety by combining the information and remediation actions necessary to effectively perform food safety inspections.

In general, while the portable food safety device 404 is described with respect to the food industry, the portable device 404 may be customized for use with any business where safe products and productivity are important. In general, the portable device 404 can be used to provide a list of inspection tasks to be performed and a list of remediation tasks to be performed in response to detection of a food event. In general, the portable device 404 allows for inspection of products and processes that at various stages of the food distribution system at distributed locations and by people who may not have scientific backgrounds. The portable device 404 provides easily understood instructions and actions associated with safety control point tasks that can be readily understood and performed by a user.

In a particular example, the food safety system 402 can include data that can be provided to the portable device 404 to guide employees so that their actions are in accordance with the best available information and the result of the remediation actions can be both preventive and constructive. The food safety system 402 and/or the portable device 404 may be adapted to identify potential hazards at a particular location and can outline the actions needed to eliminate hazards, reduce the effect of various hazards, or any combination thereof. In a particular example, the remediation tasks and the hazard inspection points may be tailored to the specific products and facilities associated with the product. The portable device 404 may be a handheld device that communicates real-time task performance guidelines to the people doing the actual work, providing important information to business personnel about what to do and when to do it.

In general, the system 400 provides a means for building employee awareness, and as employees buy into using the system 400, the overall safety and efficiency of a facility can be enhanced. Further, the portable device 404 may be carried into any facility, plant, restaurant, storage facility, transport system, or any combination thereof, to provide an interface for inspection of food products.

In general, the food safety system 402 can include a web-enabled database that communicates with the portable device 404 to provide specific task-centered real-time information that guides and records employee decision-making. Further, to assist the employee, the portable device 404 can include a camera that can be used to record digital images of particular food situations, and the portable device can transmit the image to the food safety system 402 for evaluation by expert personnel at a remote location. This feature provides an additional advantage in that the inspecting personnel need not be experts, since the portable device 404 provides a means for instant communication (phone, instant message, chat, image sharing, other communications means, or any combination thereof) with a remotely located expert to assist in identifying safety-related issues.

The bell ringer (“bell-ringer” culture) 412 assumes a particular user of the portable food-safety device 404 is motivated to detect hazards and to take actions to manage critical control points. In a particular instance, it is important for the user to have authority to make necessary decision for taking corrective action, such as stopping a production line, stopping a process, halting work impacted at a critical control point, taking other corrective action, or any combination thereof. In a particular example, the bell-ringer 412 is a user that is part of a trusted team whose action takes place before a food-related incident or problem occurs, which is different from a “whistle-blower” whose action takes place after the problem has already occurred.

The portable device 404 helps convert a manual-worker into a knowledge-worker with the outcome being a significant reduction in the worker's effective response time. As the bell-ringer 412 develops experience with the system, the effective response time can continue to improve and the overall efficiency and safety of the system will be improved. Further, close observation and management of critical safety controls also assures compliance with product specifications, which ensures product quality and safety. Further, consistent checks of critical control points can provide an early detection of a hazard before problems occur so that actions can be taken proactively to prevent a food contamination event. Taking corrective actions at critical points reduces problems and enhances throughput.

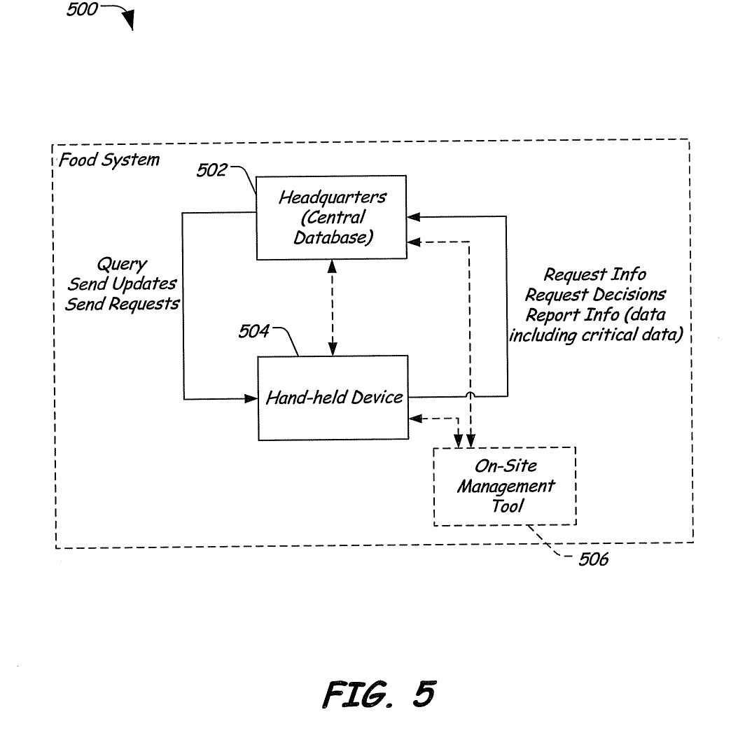

FIG. 5 is a block diagram of a particular embodiment of a system 500 to provide product quality and safety and to provide enhanced efficiency and effectiveness. The system 500 can include a headquarters (central database) system 502 that is adapted to communicate with at least one hand-held device, such as the hand-held device 504. In a particular embodiment, the hand-held device 504 can include the features and functionality of the portable hand-held computing device 304 illustrated in FIG. 3.

In a particular embodiment, the headquarters system 502 is adapted to initiate queries to trigger or prompt the hand-held device 504 to produce a detectable alert (such as a vibration, a tone, a visual indicator, or any combination thereof) in order to prompt a user to perform an action, such as to inspect a critical control point within a process. The headquarters system 502 can send software and data updates and transmit requests to the hand-held device 504. Further, the headquarters system 502 can transmit data to the hand-held device 504, including video data, audio data, text data, other information, or any combination thereof.

The hand-held device 504 is adapted to transmit information requests and decision requests to the headquarters system 502. In a particular example, the user of the hand-held device 504 can be used to capture a picture of a particular area or event and to transmit the visual image to the headquarters system 502 for instructions. Further, the hand-held device 504 can be used to report information to the headquarters system 502, such as critical control point inspection data. Additionally, the hand-held device 504 can include a display interface and an audio interface to reproduce data received from the headquarters system 502 for use by an employee.

In a particular embodiment, the system 500 can include an on-site management tool 506, which is adapted to communicate with the headquarters system 502 and the hand-held device 504. In a particular example, the on-site management tool 506 can be used to customize modules for use with the hand-held device 504 and/or with the headquarters system 502. Further, the on-site management tool 506 can be used for on-site management of employees and to provide custom modules to the hand-held device 504, including facility-specific training materials.

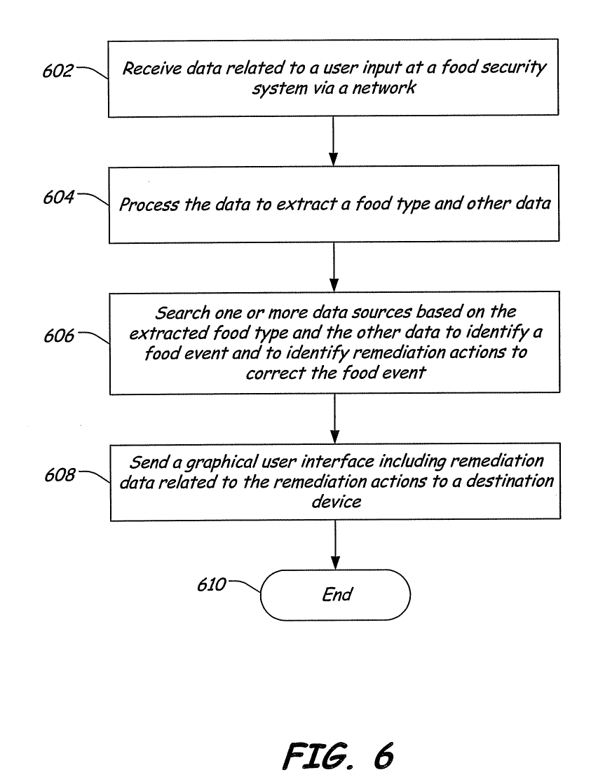

FIG. 6 is a flow diagram of a particular illustrative embodiment of a method to provide product quality and safety and to provide enhanced efficiency and effectiveness. At 602, data related to a user input is received at a food security system via a network. The food security system may be confined within a single network-accessible computer or distributed across a plurality of computing systems. In a particular example, the data may be received via a wireless connection. In another particular example, the data can include text data, image data, or any combination thereof. Continuing to 604, the data is processed to extract a food type and other data. In a particular example, the other data can include contaminant data, temperature data, spoilage data, identification of new pathogens, other food related data, or any combination thereof. Moving to 606, one or more data sources are searched based on the extracted food type and the other data to identify a food event and to identify remediation actions to correct the food event. The one or more data sources can include product specification data, a hazard database, a remediation task database, other data, or any combination thereof. Proceeding to 608, a graphical user interface including remediation data related to the remediation actions is sent to a destination device. The method terminates at 610.

In a particular embodiment, the method can include providing an expert graphical user interface (GUI) to a terminal at the food security system. The expert GUI can include the image data for review at the terminal and can include one or more selectable indicators accessible to an expert to communicate instructions to the destination device.

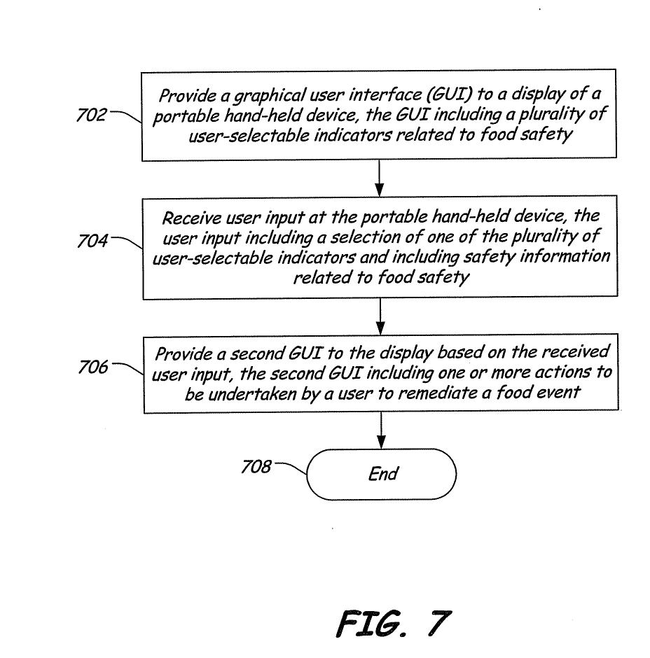

FIG. 7 is a flow diagram of a second particular illustrative embodiment of a method to provide product quality and safety and to provide enhanced efficiency and effectiveness. At 702, a graphical user interface (GUI) is provided to a display of a portable hand-held device, where the GUI can include a plurality of user-selectable indicators related to food safety. In a particular embodiment, the portable hand-held device is a mobile telephone including a display, a personal digital assistant (PDA), a portable computer, another computing device, or any combination thereof. Moving to 704, user input is received at the portable hand-held device. The user input can include a selection of one of the plurality of user-selectable indicators and can include safety information related to food safety. Proceeding to 706, a second GUI is provided to the display based on the received user input, where the second GUI can include one or more actions to be undertaken by a user to rectify a food event. The method terminates at 708.

In a particular embodiment, the method can also include sending data related to the safety information to a food safety system via a network and can include receiving remediation data from the food safety system in response to transmission of the data. In a particular example, the second GUI can include a list of one or more actions to be performed by the user based on the received remediation data. In another particular embodiment, a food event is detected at the hand-held device based on the received user input and an alert is automatically generated to the display in response to detection of the food event. In a particular example, the alert can be a user-selectable indicator within the second GUI or a changed color, font, size, other characteristic or any combination thereof, of an element within the second GUI. For example, an alert may be generated by causing text to flash or change color. Alternatively, an alert may be represented by an image, vibration, or another indicator. In another particular embodiment, the alert may also be provided to an audio output element as an audible alert, such as a speaker.

In another particular embodiment, a digital image related to food safety is captured via a camera feature of the portable hand-held device. The captured digital image is sent to the food safety system and remediation data is received from the food safety system in response to transmitting the captured digital image. In a particular illustrative embodiment, the portable hand-held device is a mobile telephone including a display, and the mobile telephone is adapted to facilitate real-time communication sessions with a user associated with the food safety system.

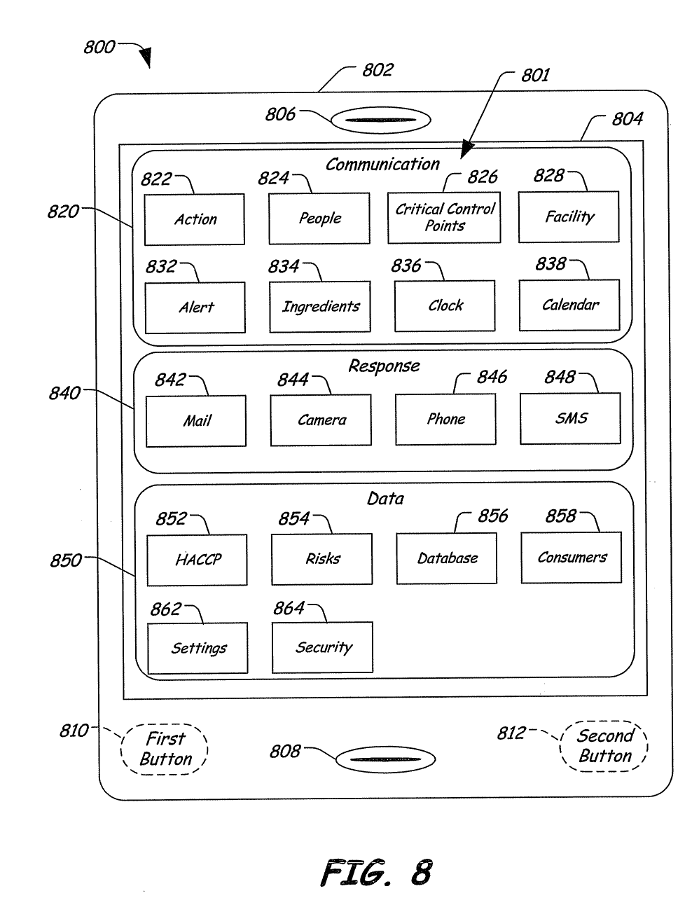

FIG. 8 is a block diagram of a particular illustrative embodiment of a portable device 800 including a user interface 801 for use with a system to provide product quality and safety and to provide enhanced efficiency and effectiveness. The portable device 800 can include a housing 802 including a display 804, a speaker 806, and a microphone input 808. The portable device 800 may also include optional buttons 810 and 812, which may be configured to access a particular function. In a particular example, the first button 810 may be configured to generate an instant shutdown of a particular food processing function, to generate an alarm, to capture a digital image, or to perform another function.

Additionally, the user interface 801 can include multiple user-selectable indicators (soft-keys) that can be configured to access various functions and features and to communication with a food safety system, such as the food safety systems 202, 302, and 402 illustrated in FIGS. 2-4. As used herein, the term “soft-key” refers to a touch screen button or other selectable element that is generated from software code rather than a physical key. The interface 801 can include a plurality of soft-keys that may be used in a restaurant application. In a particular embodiment, the interface 801 may be generated using proprietary software stored at the portable device 800. In another particular embodiment, the interface 801 may be generated based on instructions received from a network. The interface 801 may be provided within a window of a web-browser application.

The interface 801 can include a plurality of user-selectable indicators (soft-keys) that can be selected by a user to access various functions at the portable device 800. In an example, the various functions may be stored as software modules within a memory of the portable device 800, which modules may be accessed via the soft-keys. In another example, the various functions may reside at a server and may be accessed via a network connection (such as a wireless Internet connection) in response to selection of one or more soft-keys. In still another example, the various functions may be distributed between one or more servers and the portable device 800, such that the portable device 800 executes modules that are stored locally and accesses modules at the one or more servers as needed, in response to user selections. In an embodiment, the portable device 800 may download modules as needed. In another embodiment, the portable device may execute modules over the network.

The interface 801 can include a communication portion 820 that can include soft-keys to communicate data to a food safety system and to communication information and tasks to a user. In an embodiment, the interface 801 may be stored within the portable device 800. In another embodiment, the portable device 800 may retrieve the interface 801 from a server via a network connection, as needed. The interface 801 can also include a response portion 840 that can include soft-keys to access programs that facilitate direct communication between a user at the portable device and a user at the food safety system. The interface 801 can further include a data portion 850 that can include soft-keys to interact with various data sources via a network, such as the Internet.

The communication portion 820 can include an “Action” soft-key 822 to access various inspection tasks and/or remediation tasks to be undertaken by the user. The communication portion 820 can also include a “People” soft-key 824 to identify particular people involved in the food process, including the user controlling the portable hand-held device 800. The communication portion 820 can also include a “Critical Control Point” (CCP) soft-key 826 that is accessible to detect and/or record any CCP deviation including those accessed by a physical sensor, such as temperature. The communication portion 820 can further include a “Facility” soft-key 828 that allows a user to access a list of locations and to select a particular facility, which may present a context that results in facility-specific tasks to be performed by the user. The communication portion 820 may also include an “Alert” soft-key 832 that is accessible to a user to initiate an alarm or to receive an alert based on user input and/or data received from a food safety system. In a particular embodiment, when a food event is detected, the “Alert” soft-key 832 may flash or change color to provide a visual alert related to a food event and to communicate immediately using a variety of communication vehicles with various levels of management.

The communication portion 820 can also include an “Ingredients” soft-key 836 that is accessible by the user to input ingredient information, to review existing ingredient information, to review safety information related to particular ingredients, to review other ingredient information, or any combination thereof. Further, the communication portion 820 can include a “Clock” soft-key 836 that can be used to access time data and clock settings. In general, the time data may be used to provide time-stamps for user inputs. The communication portion 820 can also include a “Calendar” soft-key 838 that can be selected by a user to access a calendar feature. A user can select this option to enter data to schedule future inspections, to provide follow up information, to enter other data, or any combination thereof.

The response portion 840 can include a “Mail” soft-key 842 that can be selected by a user to access a mail program, such as electronic mail, instant message, chat, other text messages, or any combination thereof. The response portion 840 can further include a “Camera” soft-key 844 that can be selected to activate a camera feature of the portable hand-held device 800. The “Camera” soft-key 844 may be selected to capture a digital image of a food product, a process, contamination, plant conditions, some other information, or any combination thereof. In a particular embodiment, the portable hand-held device 800 is adapted to transmit the digital image to a food safety system for analysis. In an alternative embodiment, an advanced image-processing feature within the portable device 800 is adapted to compare images to identify a potential food-related problem.

The response portion 840 can also include a “Phone” soft-key 846 that can be selected by a user to initiate a phone call. The response portion 840 can also include a short message service (“SMS”) soft-key 848 that is selectable by a user to initiate transmission of an SMS text message.

The data portion 850 can include a Hazard Analysis and Critical Control Point (“HACCP”) soft-key 852 that is selectable by a user to access a list of control points for use in performing an inspection. The data portion 850 can further include a “Risks” soft-key 854 that is selectable by a user to access risk data associated with a particular facility. The data portion 850 may also include a “Database” soft-key 856 to access database data and a “Consumers” soft-key 858 to access consumer information associated with the particular facility. In a particular example, the consumer information may include data related to upstream and downstream supply data, in case a particular contamination either did not originate at the facility or has already spread to other locations through a distribution channel.

The data portion 850 can also include a “Settings” soft-key 862 that is selectable by a user to configure various settings associated with the portable hand-held device 800. Further, the data portion 850 may include a “Security” soft-key 864 that is accessible to adjust various security parameters, including password and other access features.

In general, since the keys are presented as soft-keys, the portable hand-held device 800 can be customized for use with any type of facility or process inspection. Further, the interface can be updated to account for new and changing information. In a particular example, the soft-keys of the interface 801 may change as a particular user proceeds through a set of tasks, so that the selectable soft-keys are related to the particular inspection and change as the inspection progresses.

In a particular embodiment, an example of an action accessible via the “Action” soft-key 822 can be an employee log-in. Responsible key employees at a particular location may be given a password to log-in to the device. Such people may be identified from the “People” soft-key 824. Each employee may have associated critical control points (CCPs) for which he/she is responsible and may also have associated tasks for management of CCPs indicating that the CCPs have been identified and adhered to and that at-risk situations (product quality and/or safety problems) have been flagged and communicated. The “Critical Control Points” soft-key 826 may have a color-indicator representing a status of the associated CCPs. In a particular example, when no CCPs exceed their respective thresholds, the “Critical Control Points” soft-key 826 may be green, which can be a default setting. When CCPs are exceeded and corrected, an automatic alert may be generated, and the “Critical Control Points” soft-key 826 may be yellow. When CCPs are exceeded and product is at-risk, the “Critical Control Points” soft-key 826 may be orange indicting that a decision must be made to destroy, recall and/or contact government agencies may be required. In all instances, the portable device may automatically generate an alert to a server, such as a management server to involve management in a decision-making process.

In a particular embodiment, the CCPs can include all temperature and time-dependencies, including refrigerator and freezer temperatures (monitoring temperatures between 32-41 degrees Fahrenheit in refrigeration units, temperatures below 32 degrees Fahrenheit in freezers, and other temperatures), hold-time and temperatures between cooking and serving (in a food service environment), reheating temperatures (e.g., 265 degrees Fahrenheit for meats), cooking temperatures (e.g., 260 degrees Fahrenheit for beef and chicken), oven temperatures, dishwasher temperatures, drier temperatures, and the like. Further, the CCPs can include people, facilities, and ingredient functions, which may be accessed via the “People” soft-key 824, the “Facility” soft-key 828, and the “Ingredients” soft-key 834, respectively.

In a particular embodiment, the “Ingredients” soft-key 834 can be accessed to view a menu with ingredient lists. The menu can include a drop-down list of high risk ingredients and associated actions, including checking all ingredients received to determine if the supplier is an approved supplier and if the transportation and temperatures were acceptable. Further, if the refrigerated transportation is above an acceptable temperature range (such as above 41 degrees Fahrenheit for meats and produce), the associated action can be to reject the delivery.

In a restaurant environment, the “People” soft-key can be used to access a list of all employees in a restaurant, identifying the names of key people for particular shifts and identifying those who have completed and those in need of completing particular training programs. The “People” soft-key can also be accessed to monitor control points related to sanitation/dress codes, hand-washing and glove use, sick or infection-related control points, and other information. The “People” soft-key can be used to manage employees sick days and to define “bell ringer” responsibilities for each job description at a particular facility. Also, the “People” soft-key can be used to identify the names of people to be notified in the event of a Yellow alert, such as the store manager, the regional manager, and the operations executive. In the event of an Orange alert, the people to be notified can be, for example, a vice president of quality assurance, a chief executive officer, and others, including those listed in a Yellow alert.

The “Facility” soft-key 828 can be used to access critical control points for the facility, including whether the facility meets code. For example, the CCPs for the facility can include remodeling/repairs CCPs (including monitoring a status and condition of such activities). Further, the CCPs for the facility can include layout (e.g., layout of cooking units relative to counters and coolers), identification of key equipment, identification of chemicals (including types of detergents, bactericides, pesticides, and other chemicals used), and cleaning frequencies and concerns.

In a particular embodiment, the system can automatically generate alerts based on specific issues and their timely remediation. In a food environment, for example, there may be CCPs that are exceeded, identified, and remediated without risk (such as spills on the floor that can be cleaned up quickly and without concern for food contamination). Such CCPs do not necessitate an alert, and the “Critical Control Points” soft-key 826 can be a green color indicating no alert.

When a CCP is exceeded that cannot be corrected without risk, a Yellow alert may be generated (i.e., the “Critical Control Points” soft-key 826 may be a yellow color). In a food environment, a Yellow alert may indicate that a particular food product is on hold and that the menu items are temporarily suspended, and that tests are being conducted. If the tests are negative, the product can be released and the full menu can be made available. Further, the CCP alert can be corrected by disposing of affected ingredients.

When a CCP alert is exceeded that reflects significant consumer risk, an Orange alert may be generated (i.e., the “Critical Control Points” soft-key 826 may be an orange color). This type of alert may represent an event where the ingredients and/or products are on hold pending disposal, a significant number of menu items are suspended, and a possible store closing may be required. Further, in this instance, tests indicate that there may be a significant risk to consumers, that the product was consumed hours before the hazard was recognized, and notification of local and federal government agencies may be necessary.

For both yellow and orange alerts, data may be communicated to a server system for involvement of management staff and/or experts to assist in making determinations about who and how to notify various entities. For example, in some instances, a public service announcement or recall notice may be necessary, if a particular product is widely distributed. Such notices may involve high level executives, public relations employees, and governmental agencies.

It should be understood that the above-example is focused on a food-related process, but that device may be used with other processes. In a particular example, the soft-keys 822-864 may be generated via a graphical user interface generator and may be changed to access different functionality based on instructions stored in a GUI module. Accordingly, the soft-keys and their associated functionality can be readily adjusted by changing the underlying code and without having to replace the device itself. Further, it should be understood that training videos may displayed within the user interface 801 in lieu of the soft-keys or in response to selection of a particular soft-key.

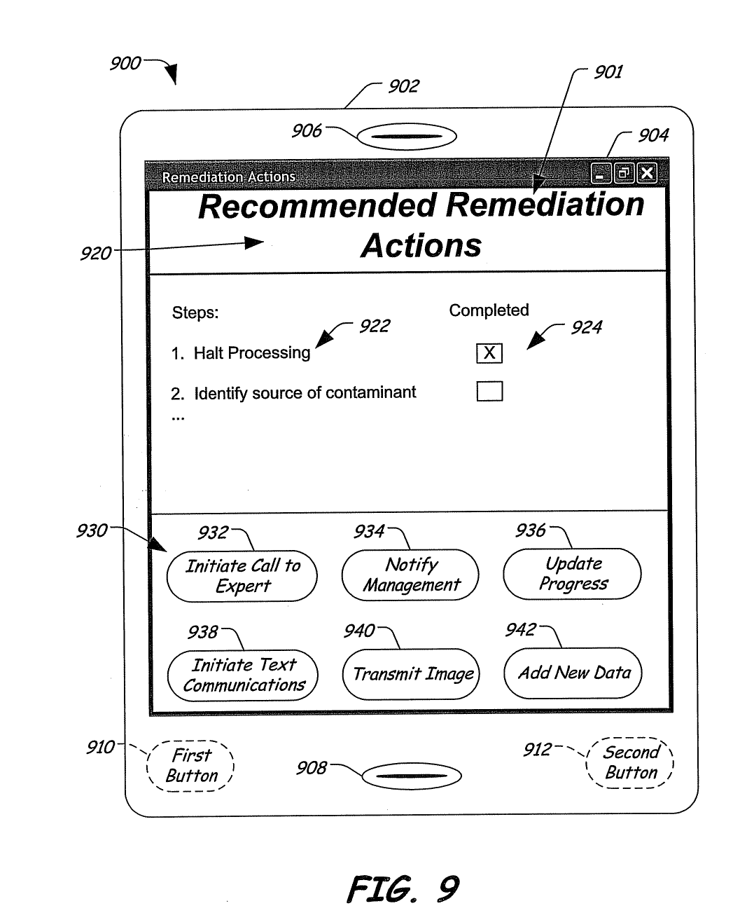

FIG. 9 is a diagram of a second particular illustrative embodiment of a portable hand-held device 900 including a graphical user interface (GUI) 901 illustrating remediation instructions displayed at a portable device for use with a system to product quality and safety and to provide enhanced efficiency and effectiveness. The hand held device 900 can include a housing 902 with display interface 904, a speaker 906, and a microphone input 908. Further, the portable hand-held device 900 can include a first button 910 and a second button 912, which may be configured to access particular functions.

The GUI 901 can include a title portion 920 that describes the content of the GUI 901. In this instance, the title portion 920 describes “Recommended Remediation Actions.” Further, the GUI 901 can include a list of actions (tasks) 922 to be followed in order to rectify a particular food event. The GUI can also include selectable elements, such as check boxes 924, which can be selected to indicate completion of a particular task from the list of actions 922. The GUI 901 can further include a control panel 930 that can include multiple soft-keys.

The control panel 930 can include an “Initiate Call to Expert” soft-key 932 that is selectable by a user to initiate a telephone call to a food safety system in order to establish a voice conversation between a user at the portable hand-held device and an expert associated with the food safety system. The control panel 930 can include a “Notify Management” soft-key 934 that can be selected by the user to initiate an alert to management, which may be an email, an instant message, another control signal, or any combination thereof. Further, the control panel 930 can include an “Update Progress” soft-key 936 that is selectable by a user to access a user input screen to update information related to an inspection, to update data related to an on-going remediation process, to enter other data, or any combination thereof. The control panel 930 can also include an “Initiate Text Communications” soft-key 938 to initiate a chat session, an instant message, a short message system (SMS) text, another text communication, or any combination thereof. Further, the control panel 930 can include a “Transmit Image” soft-key 940 that can be selected to capture a digital image and to transmit the digital image to a food safety system. The control panel 930 can also include an “Add New Data” soft-key 942 that can be used to enter new data, including updating information relating to a particular facility.

In general, it should be understood that the GUIs 801 and 901 illustrated in FIGS. 8 and 9 are illustrative only, and are not intended to be limiting. In general, the GUI 901 illustrates a web-based user interface, which may be downloaded from a web-server, such as a food safety system server. In this instance, the GUI 901 can be updated from a central server on start up so that if there are multiple portable devices, each device can be updated immediately by downloading a web page, for example. In a particular instance, the web page may include embedded extensible markup language (XML) code, embedded scripts, or other data to provide a custom interface for each facility within a particular company.

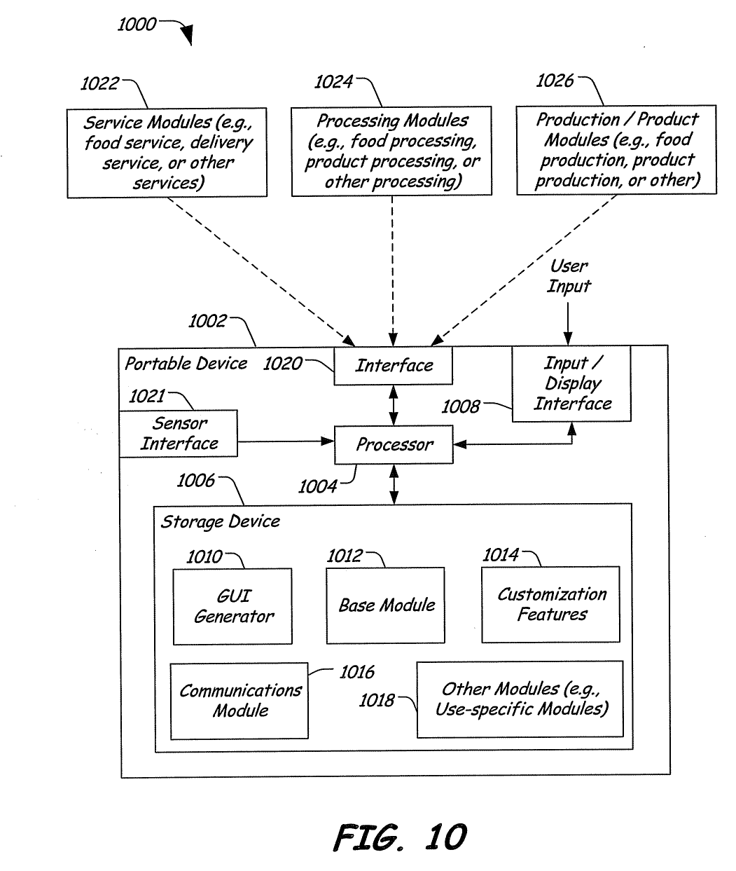

FIG. 10 is a block diagram of a third particular illustrative embodiment of a system 1000 including a portable hand-held device 1002. The device 1002 can include a processor 1004 and a storage device (memory) 1006 that is accessible to the processor 1004. The processor 1004 is also coupled to an input/display interface 1008, such as a touch-sensitive display for displaying a graphical user interface and for receiving user input. Further, the input/display interface 1008 may interface with one or more sensors to retrieve data related to a particular process, such as a temperature. The storage device 1006 can include instructions that are executable by the processor 1004. The instructions can include a graphical user interface (GUI) generator 1010 that is executable by the processor 1004 to generate a GUI that can be accessed by a user via the input/display interface 1008. Further, the instructions can include a base module 1012 that is executable by the processor 1004 to interact with one or more other modules to produce a quality and safety control system for use in a variety of industries, including food services, processing industries, production industries, or any combination thereof.

The storage device 1006 can include customization features 1014 that can be used to customize operation of the portable device 1002. Further, the storage device 1006 can include a communications module 1016 that is executable by the processor 1004 to send and receive information to and from a host system via an interface, such as the interface 1020. Additionally, the storage device 1006 can include other modules 1018, such as use-specific (facility specific) modules. Further, the system 1000 can include service modules 1022 (such as food service, delivery service, other services, or any combination thereof), processing modules 1024 (such as food processing, product processing, other processing, or any combination thereof), and production/product modules 1026 (such as food production, product assembly or distribution, other production-related operations, or any combination thereof).

In a particular embodiment, a user can access the base module 1012 via the input/display interface 1008 of the portable device 1002 to selectively download application modules from a server via the interface 1020, such as the food safety system 202 illustrated in FIG. 1. In a particular example, the portable device 1002 can include proprietary software that is modular, adaptable, and scalable. The base module 1012 can be an Internet browser, proprietary software, or any combination thereof. In a particular example, the base module 1012 can be a plug-in application that is adapted to operate in conjunction with an Internet browser application. In a particular example, a quality and safety system can include the base module 1012 and one or more other modules 1018, where each of the one or more other modules 1018 can be related to a specific service, process, or product. Further, the other modules 1018 may be customized via the customization features 1014 for a particular service provider, producer, or business. In the context of food, for example, such modules can include a food service module, a food processing module, and a food product module, each of which may be tailored to a specific business.

Further, the portable device 1002 can include a sensor interface 1021, which is adapted to receive measurement data from one or more sensors that may be located within devices at a particular facility or location. In a particular example, a temperature sensor may be placed within an oven at a food service location, which temperature sensor may be adapted to periodically transmit (wirelessly) the temperature measurement data. Alternatively, the sensor may be responsive to a query from the portable device 1002 to retrieve measurement data. In a particular embodiment, the sensor interface 1021 can include a wired interface to couple to a cable to download data from one or more sensors. In another particular embodiment, the sensor interface 1021 can include a wireless transceiver adapted to communicate with one or more sensors via a wireless protocol, such as a Bluetooth® protocol, an 802.11x protocol, another wireless protocol, or any combination thereof.

In a particular example, the portable device 1002 can be configured to include particular modules that can be customized for a particular facility, a particular process, or any combination thereof. Further, the various modules, including the service modules 1022, the processing modules 1024, and the production/product modules 1026 can include training data, such as video data, audio data, text data, or any combination thereof, which training data is related to a specific operation, function, critical control point, or other appropriate aspect of a particular operation. Such training data can be downloaded to the portable device 1002 (as needed), and an employee can access the training data via the portable device 1002. In this example, it should be understood that specific portions of available modules may be downloaded to the portable device 1002 and stored in the storage device 1006 to customize the portable device 1002 for use in a specific process, service, or production industry. Further customizations can be applied via the customization features 1014 to tailor particular modules to a specific facility, process, or function.

Additionally, it should be understood that the inspection tasks and the remediation tasks may be displayed as lists, which include specific items that can be accessed to retrieve detailed information including specific steps to be performed. Further, the inspections tasks and remediation tasks may include specific questions to be answered. In a particular embodiment, the GUI may include a map of a facility and the inspection points may be displayed on the map to assist and guide a user through a particular facility so that critical control points are not overlooked.

While the above-discussion has largely focused on food systems, it should be understood that food safety is used herein as a particular illustrative application. In practice, the portable device and the safety and quality systems described above with respect to FIGS. 1-9 can be employed in any environment and can be tailored to fit the specific quality control and safety control needs of a particular environment. Since the portable device utilizes modular systems, the modules can be downloaded and used as needed and the modules can be tailored to a specific facility, so that the device need not be “one-size fits all”. Instead, the customized devices can be provided to each facility to fit the quality control and safety concerns of the particular facility. Further, training data can be produced that can be tailored to the facility and provided to a user (as needed) to enhance overall productivity. Additionally, it should be understood that various functions may be stored on a server and retrieved by a portable device as needed, may be stored locally within the portable device, or any combination thereof.

Although the present invention has been described with reference to preferred embodiments, workers skilled in the art will recognize that changes may be made in form and detail without departing from the spirit and scope of the invention.

What is claimed is:

1. A portable, hand-held device to manage product quality and safety, the device comprising:
a processor;
a memory accessible to the processor and comprising instructions executable by the processor to:
collect data related to a particular location;
generate a graphical user interface (GUI) including a plurality of user-selectable elements accessible by a user, the plurality of user-selectable elements including a first user-selectable element to initiate playback of a training video, a second user-selectable element to receive user input associated with the particular location, and a third user-selectable element to display data indicating critical task information including actions to be taken by the user in response to the collected data; and
a display interface responsive to the processor and adapted to display the GUI.

2. The device of claim 1, further comprising a sensor interface responsive to a plurality of sensors to receive measurement data.

3. The device of claim 1, further comprising a network interface responsive to a network and adapted to communicate with a server to transmit collected data.

4. The device of claim 3, wherein the portable device is adapted to selectively retrieve data from the server, the data including at least one of actions to be taken by the user in response to the collected data, training video data, and processor executable instructions.

5. The device of claim 3, wherein the GUI further comprises a fourth user-selectable indicator accessible to a user to initiate communication with a manager regarding data related to the particular location.

6. The device of claim 3, further comprising a camera interface to capture image data related to the particular location.

7. The device of claim 1, wherein the memory further comprises customized modules executable by the processor and tailored to the particular location.

8. The device of claim 1, further comprising:
event detection logic executable by the processor to detect a product quality related problem based on the collected data; and
alert generation logic executable by the processor to generate an alert that is detectable by the user in response to detection of the product quality related problem.

9. The device of claim 8, wherein the alert comprises at least one of an audible sound, a visual indicator, or a tactile indicator.

10. The device of claim 8, further comprising a remediation module that is executable by the processor to provide instructions for resolving the product quality related problem to the user via the GUI, the instructions comprising instructions tailored to the particular location.

11. A system comprising:
an interface responsive to a network and adapted to receive data and requests via the network;
processing logic coupled to the interface; and
memory accessible to the processing logic to store instructions executable by the processing logic to:
receive data from a remote device via the interface;
provide training data to the remote device via the interface in response to the received data, the training data including video data tailored for use at a particular location, wherein the training data is related to product quality and safety.

12. The system of claim 11, further comprising:
a communications module executable by the processing logic to receive critical control point data from the remote device via the interface, the critical control point data including information related to controllable components at the particular location that relate to product quality and safety;
an event detection module executable by the processing logic to detect a product quality related problem based on the collected data.

13. The system of claim 12, further comprising an alert generation module executable by the processing to generate an alert.

14. The system of claim 13, wherein the alert is communicated to the remote device via the interface to produce a user-detectable alert at the remote device.

15. The system of claim 13, wherein the alert is communicated to an expert terminal for evaluation by an operator.

16. The system of claim 13, further comprising a remediation module that is executable by the processing logic to selectively provide remediation information that is related to the particular location and to the detected product quality related problem, the remediation information including a list of actions to be undertaken by an employee to correct the product quality related problem.

17. A hand-held device for inspecting a facility, the device comprising:
a speaker to output audio information;
a display interface to display a graphical user interface including a window operable to provide instructions, to reproduce video data, and to display user-selectable options related to inspection of the particular facility;
a processor coupled to the speaker and the display interface; and
a memory accessible to the processor to store a plurality of instructions comprising instructions executable by the processor to:
receive data related to control points related to product safety and product quality at the particular facility;
detect a product related problem based on the received data; and
generate an alert to notify an employee about the product related problem.

18. The device of claim 17, wherein the display interface comprises a touch screen for receiving user input data, wherein the received data includes user input data.

19. The device of claim 18, further comprising a sensor interface coupled to the processor and responsive to a plurality of sensors to collect measurement data related to the control points, wherein the received data includes the measurement data.

20. The device of claim 17, further comprising:
a microphone coupled to the processor to collect audio data; and
a camera coupled to the processor to capture image data related to the particular facility, wherein the captured image data comprise at least one of a photograph and a video.

21. The device of claim 17, further comprising a network interface coupled to the processor and adapted to communicate with a server via a network, the processor to communicate data related to the product related problem to the server via the network interface.

22. The device of claim 21, wherein the network interface is accessible by the processor to selectively download training video data related to the particular facility.

23. The device of claim 21, wherein the network interface is accessible by the processor to selectively download one or more modules that are executable by the processor to perform particular operations related to inspection of the particular facility.
